(19) United States
(12) Patent Application Publication
(10) Pub. No.: US 2021/0123546 A1
(43) Pub. Date: Apr. 29, 2021

(54) Air Hose Arrangement And Method For Supplying Pressurized Air To A Movable Hoist

(71) Applicants: James Zaguroli, JR., Auburn Hills, MI (US); Roger Hamilton, Auburn Hills, MI (US); Steve Sowter, Sterling Heights, MI (US)

(72) Inventors: James Zaguroli, JR., Auburn Hills, MI (US); Roger Hamilton, Auburn Hills, MI (US); Steve Sowter, Sterling Heights, MI (US)

(21) Appl. No.: 17/079,996

(22) Filed: Oct. 26, 2020

Related U.S. Application Data
(60) Provisional application No. 62/926,023, filed on Oct. 25, 2019.

(51) Int. Cl. F16L 3/18; F16L 3/20

(52) U.S. Cl. CPC F16L 3/18; F16L 3/20

(57) ABSTRACT

An arrangement of pressurized air hoses and method for supplying pressurized air to pneumatically separated equipment such as hoists as the hoist is moved along a support rail. A series of pairs of lengths of air hoses are connected together at either end which are initially vertically oriented and packed together. As the hoist is manually moved along it causes the upper ends of the lengths to be swung apart from each other eventually becoming substantially horizontal. This movement causes the overall length of the series to be substantially lengthened allowing the hoist movement to occur while its need for pressurized air being maintained all along its range of movement.

### CROSS REFERENCE TO RELATED PATENT APPLICATIONS

This application claims the benefit of U.S. provisional patent application No. 62/926,023 filed on Oct. 25, 2019.

### BACKGROUND OF THE INVENTION

The present invention concerns supplying pressurized air to overhead moving pneumatic hoists which need to be connected to a source of pressurized air so as to be able to be operated all along its range of movement.

Such hoists are widely used in assembly plants to lift parts with a hoist at one location and transporting the hoist and part to another location where it is lowered again by operation of the hoist. Such hoists are mounted for movement along an overhead rail to enable raising a part at one location and then manually pulled along the rails to another location where it is lowered.

These hoists are typically operated with air pressure supplied by an air hose connected at one end to a stationary air pressure source and extends to the hoist to which it is fixed. The hoses are typically coiled, with coil turns stretched apart as the hoist is manually pulled away from the fixed air pressure source in order to maintain a connection of the hoist with the pressurized air source. Use of the coiled hoses keeps the hose out of the way since they are shorter than straight hoses long enough to reach the hoist at its furthest position away from the source.

Spring operated wind-up drums for the hoses are also sometimes employed for the same reason.

One problem is the necessity of pulling on the coiled hose to stretch the same in order to allow the hoist to move along its supporting rail while still being connected to the air pressure source. This involves significant physical exertion. This is also a disadvantage of unwinding hose from a spring loaded drum. This constant physical exertion can become particularly burdensome when it is contently needed to be done.

In another arrangement, a series of loops of hose are placed on a series of movable hose carriers spaced along the bottom of a supporting rail. However, such carriers stack up at the end of the supporting rail to substantially shorten the useful length of the supporting rail.

It is an object of the present invention to provide an arrangement of hoses and a method for supplying hoists with pressurized air which does not require the effort required to stretch and lengthen a coiled hose nor the long lengths of hose needed to form such coiled hoses.

It is another object of the invention to provide a hose arrangement and method which reduces the extent of stack up of hose carriers at the end of a supporting rail shortening the useful length thereof.

### SUMMARY OF THE INVENTION

The hose arrangement according to the invention comprises pairs of relatively long lengths of air hoses connected to each other at lower ends thereof by a dual axis pneumatic air swivel of a type commercially available such as under the trademark DynaSwivel sold by Dynabrade, Inc. of Tonawanda, N.Y.

The upper ends of each of the pairs of hoses are each connected to one end of horizontal pipes mounted to a corresponding trolley movable along a support rail thereby connect together the upper ends of each of the pairs of hose lengths. The trolleys can all be mounted on a single horizontal trolley rail but preferably a separate rail is provided for each trolley for a reason to be disclosed below which can roll along the length thereof. The upper end of one of the pair of lengths of hoses is rotatably connected to one end of the pipe or other tubular piece on one trolley with the other length of hose rotatably connected to an end of the pipe on the other trolley. The connection of each of the upper ends of the hoses to a respective end of a pipe on each trolley end is preferably accomplished by a single axis pneumatic swivel fittings.

Each of the trolleys are preferably mounted on a separate trolley support rail so that each hose trolley can move past the other hose trolley since mounted on its own rail without interference between since each hose length has its own support rail spaced apart from the other or others if more than two trolleys are provided. This also enables movement of the trolleys in both directions.

The remaining ends of the pipes can each have another hose to be used to connect the hose arrangement at one end to a movable hoist and to a fixed source of pressurized air at the other end.

Because of the reverse movement capability, the pressurized air supply can therefore be centered along the length of the trolley support rails, to reduce the number of pairs of hoses needed since only hoses long enough to extend one half of the total distance of hoist travel.

The hose lengths are vertically oriented and close together initially but are swung apart when the twist continues to pull on the hose lengths increasingly lengthened and eventually become substantially horizontal when the hoist is at its maximum range.

The hose arrangement according to the present invention also substantially lessens the physical exertion required to pull the hose lengths compared to stretch out the coiled up hoses since significant bending of the hoses is not required. Only a few of the air line swivel fittings are required.

Only minimal effort is required pivot the hoses in each pair since bending of the hoses is not required, i.e., only pivoting of the pneumatic air swivels, and there are only a limited number of those required.

The method according to the invention maintains a supply of pressurized air to a hoist or other equipment able to be moved on a support rail toward and away from a source of pressurized air and includes the steps of connecting the hoist or other equipment with the source by a series of lengths of air hose pivotally connected together at their ends thereof and causes the lengths of hoses to pivot so as to assume an upright orientation when the hoist is moved sufficiently close to the source of pressurized air, with the air hose length closest to the source connected at an upper end to the source of pressurized air.

This also causes the lengths of air hose to be swung apart from each other by pivoting of the lower end pivotal connections by manually pulling the hoist away from the source while maintaining a fluid flow connection therebetween so that the lengths of air hose become more and more horizontal upon continued movement caused by the manual pulling of the hoist or other equipment away from the source until becoming substantially horizontal at a maximum extent of movement of the hoist or other equipment away from the source of pressurized air.

### DESCRIPTION OF THE DRAWING FIGURES

FIG. 1 is a side view of an air hose arrangement according to the present invention in a partially lengthened state which can be associated with a movable pneumatically operated hoist or other piece of equipment and a fixed source of pressurized air as shown.

FIG. 2 is an enlarged perspective view of one of the trolleys incorporated in the hose arrangement shown in FIG. 1, along with portions of trolley guide rails shown in broken lines.

FIG. 3 is an end view of the two of the trolleys and associated support rails as incorporated in an air hose arrangement including the two trolley version shown in FIG. 1.

FIGS. 4-6 are diagrammatic depictions of the air hose arrangement according to the invention shown in FIGS. 1-3, but with four trolleys instead of two, in the completely shortened state (FIG. 4), a partially lengthened state, (FIG. 5), and a completely lengthened state (FIG. 6).

FIGS. 7 and 8 are diagrammatic depictions of a shorter reversible hose arrangement which can be deployed on either side of a centered pressurized air source.

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

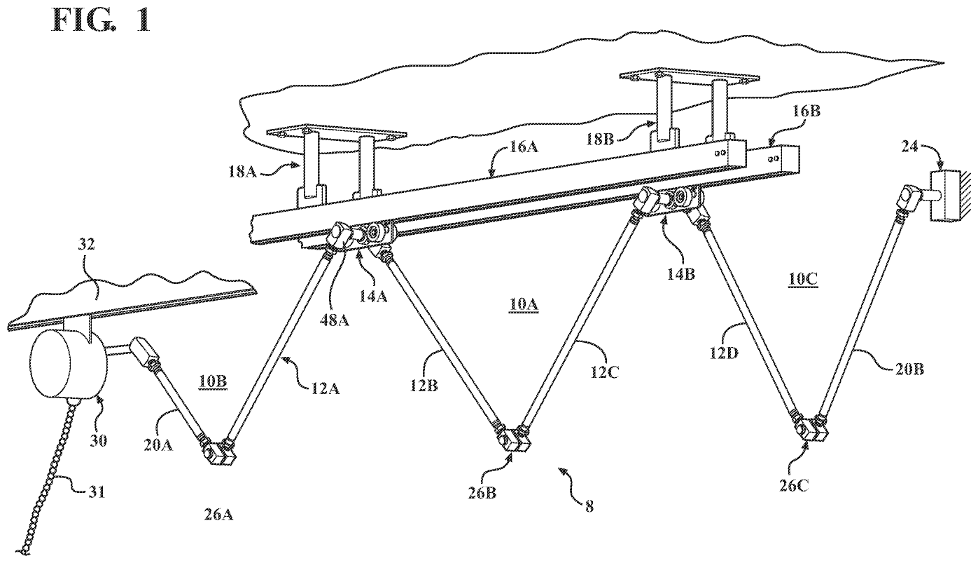

Referring to the drawings, FIG. 1 shows an arrangement of air hoses 8 comprised at least one intermediate pair 10A comprised of hoses 12B, 12C and first and second end pairs of hoses 20A, 12A and 12D, 20B.

The intermediate pair of air hoses 12B, 12C are associated with respective trolleys 14A, 14B movably mounted on respective spaced apart rails 16A, 16B shown in fragmentary view for movement along the length of the rails in either direction.

The rails 16A, 16B are supported by mount sets 18A, 18B.

An end pair of hoses 20A connected to hose 12A is able to be connected to a hoist 22 movable on a hoist 30 support rail 32. This movement is produced by manually pulling on a chain 31 in the well known practice. The other pair of end hoses comprised of end hoses 12D, 20B is associated with a non-moveable source of pressurized air 24.

The lower ends of hoses 20A, 12A are connected together by a dual axis air line fitting 26A mentioned above.

Another dual axis air line fitting 26B, connect the lower ends of air hose 12B and 12C.

Air hoses 12D, 20B are connected together by a third dual axis air line fitting 26C.

Such swivel fittings 26 are well known in the art and allow air flow from source 24 to hoist 30 flowing from one hose to the other.

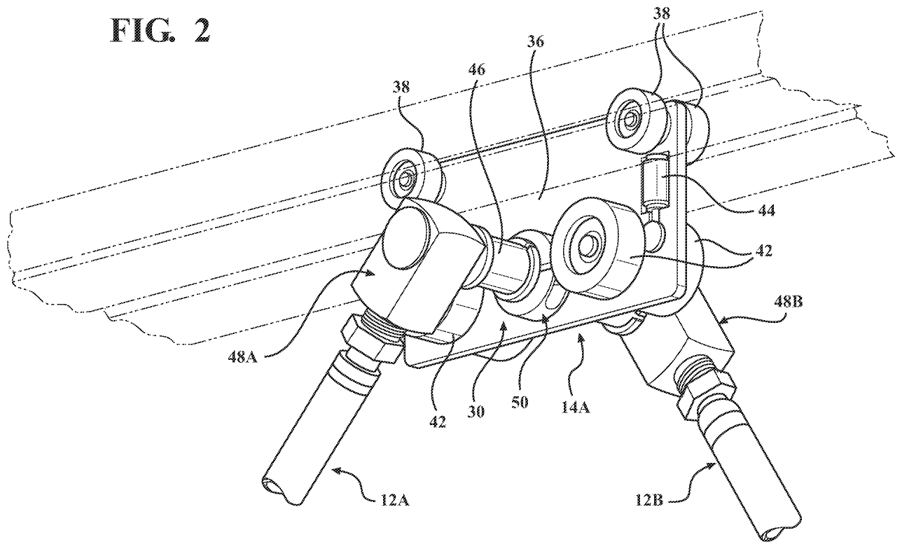

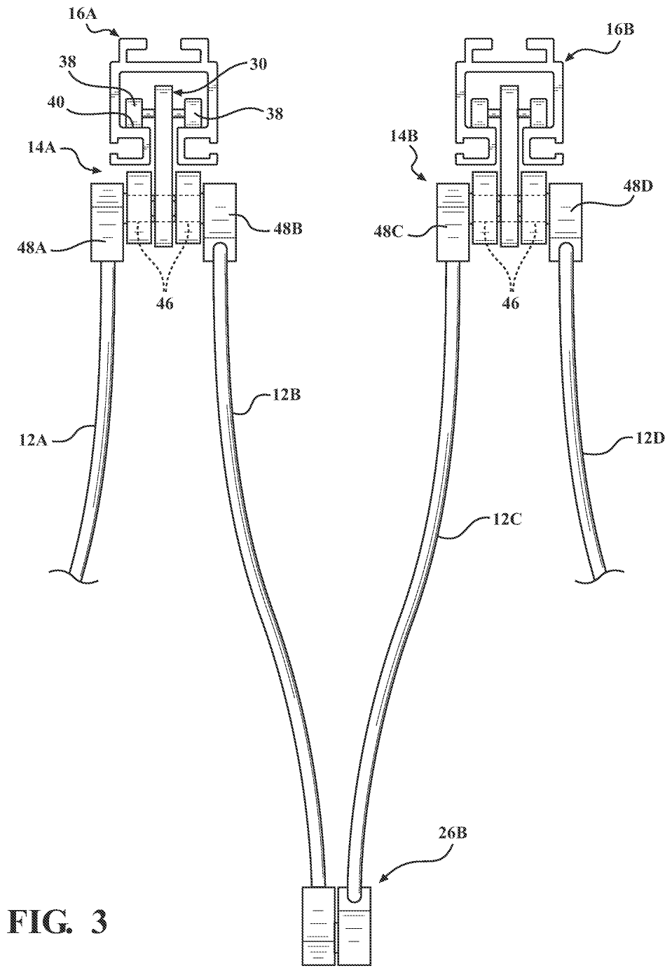

Referring to FIGS. 2 and 3, an enlarged perspective view of one of the trolleys 14A, 14B is shown, trolley 14B being the same, as well as a fragmentary portion of connected hoses 12A, 12B, hoses 12C, 12D being identical.

The trolleys 14A, 14B each include a main plate 36 mounting two sets of running wheels 38 resting on support surfaces 40 (FIG. 3) defined within each trolley rail 16A, 16B. Trolley rails 16A, 16B are commercially available as a standard product from Knight Global of Auburn Hills, Mich., No. TR2000 Rail.

A set of kick up wheels 42 mounted on the plate 30 prevent excessive bounce up of the trolleys 14A, 14B.

Side guide rollers 44 are also provided.

A pipe 46 extends through the plate 30 having an end on either side of the plate 30.

Hose 12A is connected to the pipe end closest to the viewer, preferably by means of a single axis air line swivel fitting 48A, while the end of the pipe 46 passes through the plate 30 in FIG. 2 and on the right in FIG. 3.

A clamp 50 allows positioning and fixing of the pipe 46 with respect to the plate 30.

Hose 12B is attached to the end of the pipe 46 on the far side of plate 30 as best seen in FIG. 3.

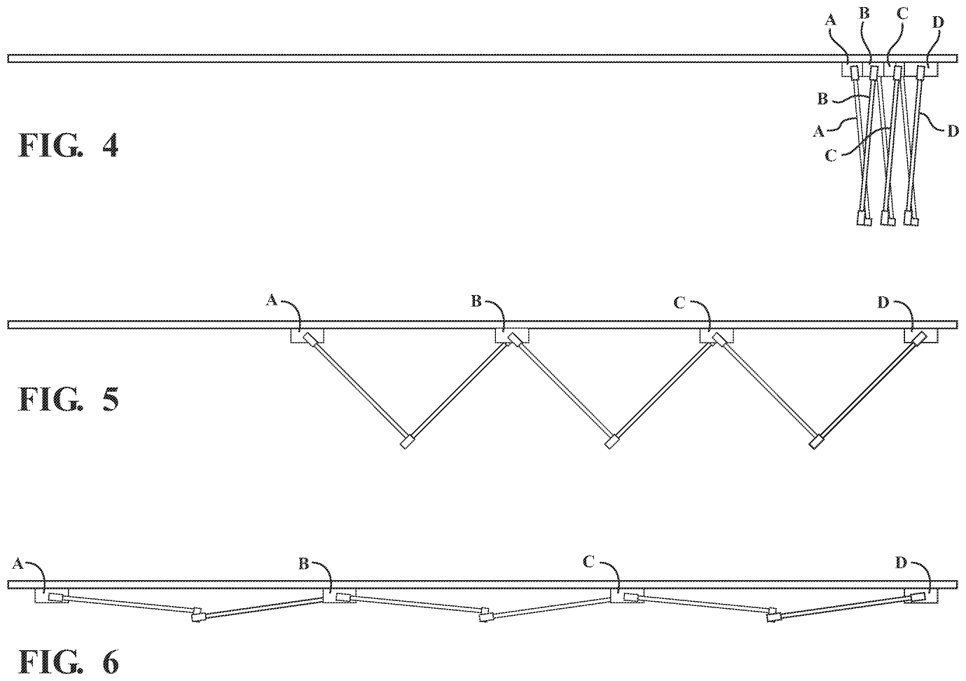

Referring to FIGS. 4-6, these Figures depict the basic motions of the hose lengths when the hoist or other equipment, etc., is being advanced by being pulled by the chain 31.

Pressurized air remains available for operation of the hoist (not shown) all along the way as he hoist is pulled further away from fixed pressurized source (not shown).

Thus, in FIG. 5, the leading trolley A has been moved a substantial distance. This causes the trailing trolleys B-C to also be moved since movement of the leading trolley A causes substantially the same movement to occur by the remaining trolleys B and C due to the nature of the mechanical connection.

When there is further movement to the maximum extent, the maximum spacing distance is reached when the hose lengths are nearly horizontal, as shown in FIG. 6.

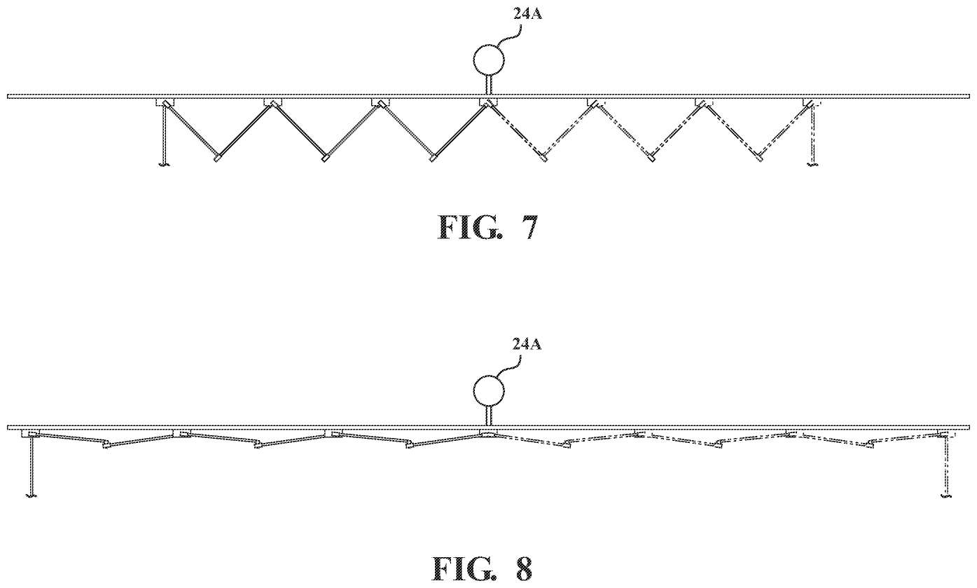

FIGS. 7 and 8 show movement when a pressurized source of air 24A is located in the middle of a span and a shortened hose arrangement is operated by pulling in either direction.

1. An arrangement of air hoses for supplying pressurized air to a movable hoist as said hoist is moved away from a fixed source of pressurized air, comprising:
at least one pair of hose lengths, being connected together at bottom ends thereof by a dual axis pneumatic air swivel to allow pressurized air to flow from the bottom end of one hose and into the bottom end of the other hose with both of said hoses extending upwardly from said connected lower ends;
at least two trolleys for said at least one pair of hose lengths, each trolley rollable on a respective trolley rail, each trolley having a pipe mounted thereto extending crosswise to said trolley rail to thereby have an end on each side of each of said trolleys;
one end of each pipe connected to an upper end of one of said hose lengths by a pneumatic air swivel and the other trolley pipe end connected to a hose, one of a first end pair of hose lengths, the other hose of said end pair of hoses connected to a movable hoist to supply pressurized air thereto and the other end of said other trolley pipe connected to a one hose of a second end pair of hoses having the other end pair of hoses connected to a pressurized air source to supply pressurized air to said arrangement of air hoses and thence to said movable hoist.

2. A method of maintaining a connection from a source of pressurized air to a movable hoist as it moves away from said fixed source of pressurized air, comprising:
providing at least one intermediate pair of air hose lengths connecting each pair of said intermediate pair of hose lengths at bottom ends thereof by a dual axis pneumatic air swivel so as to allow pressurized air to flow from the bottom end of one hose and into the bottom end of the other hose; extending both of said hoses upwardly from said connected lower ends;
providing at least two trolleys, each trolley rollable on a provided respective trolley rail, mounting a pipe on each trolley so as to extend crosswise to said respective trolley rail so that a respective end of each pipe is located on a respective side of each of said trolleys;
connecting one end of each pipe to an upper end of one of said at least one intermediate pair of hose lengths by a pneumatic air swivel and connecting the other end of one of said trolley pipes to one hose of a first end pair of hoses also connected together at their lower ends thereof, the other end of one of said pipes able to be connected to said movable hoist to supply pressurized air thereto and said other end of said other pipe connected to an upper end of an upper end of one hose of a second end pair of hoses, an upper end of a second hose of said second pair of hoses available to be connected to said fixed pressurized air source to supply pressurized air to said air hoses and thereby to said movable hoist.

3. A method of maintaining the connection of a source of pressurized air to a hoist able to be moved along a support rail toward and away from said source of pressurized air including the steps of connecting said hoist with said source by at least one intermediate pair of lengths of air hoses pivotally connected together at lower ends thereof;
causing said lengths of hoses to pivot so as to assume an upright orientation when said hoist is moved sufficiently close to said source of pressurized air, with said air hose length closest to said source connected at an upper end to said source of pressurized air;
causing said lengths of air hose to be swung apart by pivoting of about said lower end pivotal connections by manually pulling said hoist away from said source while maintaining a fluid connection therebetween so that said lengths of air hoses become more horizontal with continued movement caused by manual pulling of said hoist or away from said source until becoming substantially horizontal at a maximum extent of movement of said hoist away from said source of pressurized air.
